(19) United States
(12) Patent Application Publication
(10) Pub. No.: US 2026/0004595 A1
(43) Pub. Date: Jan. 1, 2026

(54) PRECEDING VEHICLE IDENTIFICATION APPARATUS, PRECEDING VEHICLE IDENTIFICATION METHOD, AND NON-TRANSITORY COMPUTER-READABLE MEDIUM

(71) Applicant: NEC Corporation, Tokyo (JP)

(72) Inventors: Yanbin CHEN, Tokyo (JP); Satoshi YAMAZAKI, Tokyo (JP)

(73) Assignee: NEC Corporation, Tokyo (JP)

(21) Appl. No.: 19/245,667

(22) Filed: Jun. 23, 2025

(30) Foreign Application Priority Data
Jul. 1, 2024 (JP) 2024-106188

(51) Int. Cl. G06V 20/58; G06T 7/20; G06T 7/50; G06T 7/73

(52) U.S. Cl. CPC G06V 20/58; G06T 7/20; G06T 7/50; G06T 7/73; G06T 2207/30252; G06V 2201/08

(57) ABSTRACT

A preceding vehicle identification apparatus according to the present disclosure acquires front information including information about a region of a road included in a captured image obtained by capturing an image of a scene in front of a target vehicle and information about one or more vehicles on the road, identifies a reference point of the target vehicle in the captured image using the front information, identifies a relative distance and a relative direction with respect to the reference point for each vehicle indicated in the front information, and identifies a preceding vehicle for the target vehicle based on the relative distance and the relative direction identified for each vehicle. The preceding vehicle is a vehicle closest to the target vehicle among vehicles traveling on a lane same as a lane of the target vehicle.

### INCORPORATION BY REFERENCE

This application is based upon and claims the benefit of priority from Japanese patent application No. 2024-106188, filed on Jul. 1, 2024, the disclosure of which is incorporated herein in its entirety by reference.

### TECHNICAL FIELD

The present disclosure relates to a preceding vehicle identification apparatus, a preceding vehicle identification method, and a non-transitory computer-readable medium.

### BACKGROUND ART

A technique for analyzing a situation around a vehicle traveling on a road using a sensor provided in the vehicle has been developed. For example, JP 2006-335223 A discloses a technique of detecting a traveling lane of a host vehicle based on a yaw rate detected using a yaw rate sensor and detecting a preceding vehicle on the detected traveling lane.

### SUMMARY

JP 2006-335223 A does not mention a method of detecting a preceding vehicle without using a yaw rate sensor. The present disclosure has been made in view of this problem, and an example object of the present disclosure is to provide a preceding vehicle identification apparatus, a preceding vehicle identification method, and a program for detecting a preceding vehicle using a sensor provided in a vehicle.

A preceding vehicle identification apparatus according to an example aspect of the present disclosure includes at least one memory that is configured to instructions and at least one processor that is configured to execute the instructions to: acquire front information including information about a region of a road included in a captured image obtained by capturing an image of a scene in front of a target vehicle and information about one or more vehicles on the road; identify a reference point of the target vehicle in the captured image using the front information; identify a relative distance and a relative direction with respect to the reference point for each vehicle indicated in the front information; and identify a preceding vehicle for the target vehicle based on the relative distance and the relative direction identified for the each vehicle. The preceding vehicle is a vehicle closest to the target vehicle among the vehicles traveling on a lane same as that of the target vehicle.

A preceding vehicle identification method executed by one or more computers according to an example aspect of the present disclosure includes: acquiring front information including information about a region of a road included in a captured image obtained by capturing an image of a scene in front of a target vehicle and information about one or more vehicles on the road; identifying a reference point of the target vehicle in the captured image using the front information; identifying a relative distance and a relative direction with respect to the reference point for each vehicle indicated in the front information; and identifying a preceding vehicle for the target vehicle based on the relative distance and the relative direction identified for the each vehicle. The preceding vehicle is a vehicle closest to the target vehicle among the vehicles traveling on a lane same as that of the target vehicle.

A non-transitory computer-readable medium according to an example aspect of the present disclosure stores a program that causes one or more computers to execute: acquiring front information including information about a region of a road included in a captured image obtained by capturing an image of a scene in front of a target vehicle and information about one or more vehicles on the road; identifying a reference point of the target vehicle in the captured image using the front information; identifying a relative distance and a relative direction with respect to the reference point for each vehicle indicated in the front information; and identifying a preceding vehicle for the target vehicle based on the relative distance and the relative direction identified for the each vehicle. The preceding vehicle is a vehicle closest to the target vehicle among the vehicles traveling on a lane same as that of the target vehicle.

According to the present disclosure, there is provided a new technology for detecting a preceding vehicle using a sensor provided in a vehicle.

### BRIEF DESCRIPTION OF DRAWINGS

FIG. 1 is a diagram illustrating an outline of an operation of a preceding vehicle identification apparatus;

FIG. 2 is a block diagram illustrating a functional configuration of a preceding vehicle identification apparatus;

FIG. 3 is a block diagram illustrating a hardware configuration of a computer that implements the preceding vehicle identification apparatus;

FIG. 4 is a flowchart illustrating a flow of processing executed by the preceding vehicle identification apparatus;

FIG. 5 is a diagram illustrating a configuration of front information;

FIG. 6 is a diagram illustrating a reference point;

FIG. 7 is a second diagram illustrating an outline of an operation of the preceding vehicle identification apparatus;

FIG. 8 is a second block diagram illustrating a functional configuration of the preceding vehicle identification apparatus;

FIG. 9 is a second flowchart illustrating a flow of processing executed by the preceding vehicle identification apparatus; and

FIG. 10 is a flowchart illustrating a flow of processing of detecting cut-in and cut-out.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description. Unless otherwise described, predefined values such as predefined values and threshold values are stored in advance in a storage device or the like accessible from an apparatus using the values. Furthermore, unless otherwise described, the storage unit includes one or more storage devices of any number.

### First Example Embodiment

### Overview

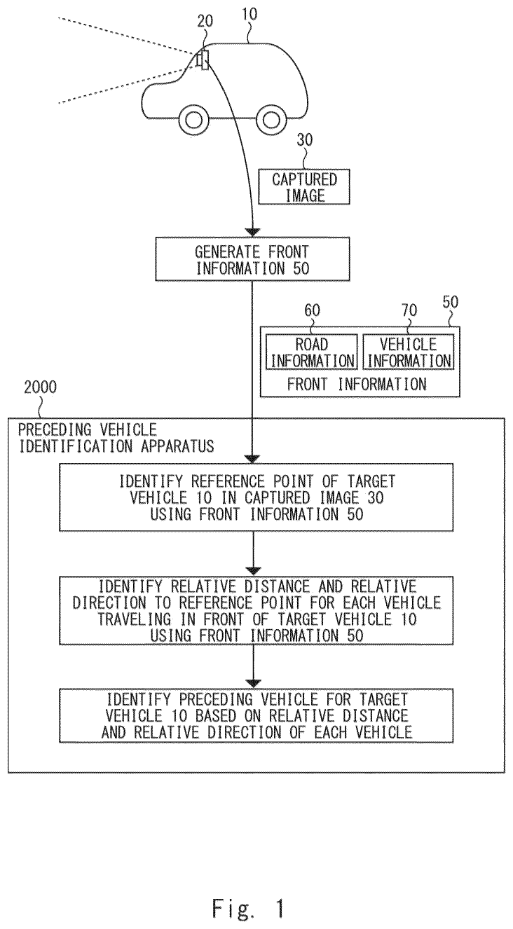

FIG. 1 is a diagram illustrating an outline of an operation of a preceding vehicle identification apparatus 2000. FIG. 1 is a diagram for facilitating understanding of the outline of the preceding vehicle identification apparatus 2000, and the operation of the preceding vehicle identification apparatus 2000 is not limited to that illustrated in FIG. 1.

The preceding vehicle identification apparatus 2000 identifies the preceding vehicle for a target vehicle 10 using the information obtained from a captured image 30. The preceding vehicle for the target vehicle 10 is a vehicle closest to the target vehicle 10 among vehicles traveling in the same lane as the lane (hereinafter, the target lane) on which the target vehicle 10 is traveling.

The captured image 30 is an image generated by a camera 20 capturing an image of a scene in front of the target vehicle 10. In front of the target vehicle 10 can also be referred to as a traveling direction of the target vehicle 10. For example, the camera 20 is configured to generate an image frame sequence that is time-series data of the captured image 30 by repeatedly capturing an image of a scene in front of the target vehicle 10. In this case, captured image 30 is one of the plurality of image frames constituting the image frame sequence.

The camera 20 is provided to image a scene in front of the target vehicle 10. For example, the camera 20 is provided on the windshield of the target vehicle 10. The camera 20 is only required to be configured to capture a scene in front of the target vehicle 10, and the capturing direction of the camera 20 does not need to completely match the traveling direction of the target vehicle 10.

For example, the camera 20 is a camera used as a drive recorder. In addition, for example, the camera 20 may be a camera used for controlling traveling of the target vehicle 10. The control of traveling of the target vehicle 10 is, for example, automatic control such as steering, acceleration, or braking.

In order to identify a preceding vehicle for the target vehicle 10, the preceding vehicle identification apparatus 2000 acquires front information 50 generated using the captured image 30. The front information 50 indicates the road information 60 that is information related to an image region (hereinafter, the road region) of a road included in the captured image 30, and the vehicle information 70 that is information related to an image region (hereinafter, vehicle region) of the vehicle included in the captured image 30. The front information 50 may be generated by the preceding vehicle identification apparatus 2000 itself.

The preceding vehicle identification apparatus 2000 identifies a reference point of the target vehicle 10 in the captured image 30 using the front information 50. Further, the preceding vehicle identification apparatus 2000 identifies a relative distance and a relative direction of each vehicle with respect to the reference point using the front information 50. Hereinafter, the combination of the relative direction and the relative direction is also referred to as a relative position.

The preceding vehicle identification apparatus 2000 identifies the preceding vehicle for the target vehicle 10 based on the relative position identified for each vehicle. Specifically, the preceding vehicle identification apparatus 2000 identifies one or more vehicles traveling on the target lane, and identifies a vehicle having the smallest relative distance among the identified vehicles as the preceding vehicle.

### Example of Operation and Effect

According to the preceding vehicle identification apparatus 2000, the preceding vehicle for the target vehicle 10 is identified using the front information 50 obtained from the captured image 30 in which the scene in front of the target vehicle 10 is captured. Therefore, according to the preceding vehicle identification apparatus 2000, there is provided a technology capable of identifying the preceding vehicle for the target vehicle 10 without using the yaw rate sensor.

More specifically, the preceding vehicle identification apparatus 2000 identifies a reference point of the target vehicle 10 in the captured image 30 using the front information 50, and further identifies a relative position (a relative distance and a relative direction) of each vehicle with respect to the reference point. The preceding vehicle identification apparatus 2000 identifies the preceding vehicle based on the relative position of each vehicle.

According to this method, it is possible to identify a vehicle traveling on a lane same as that of the target vehicle 10 from the captured image 30 without performing lane detection using white line detection. Therefore, the preceding vehicle identification apparatus 2000 can identify the preceding vehicle even in a situation where it is difficult to detect the lane from the captured image 30. Examples of the situation in which it is difficult to detect the lane from the captured image 30 include a situation in which the display of the lane on the road is thin, a situation in which the road is wet with rain, and the like.

Hereinafter, the preceding vehicle identification apparatus 2000 of the present example embodiment will be described in more detail.

### Example of Functional Configuration

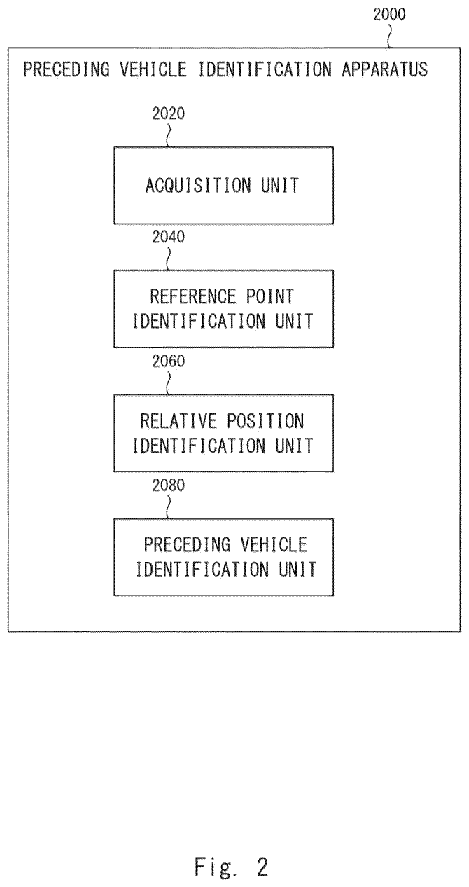

FIG. 2 is a block diagram illustrating a functional configuration of the preceding vehicle identification apparatus 2000. In the example of FIG. 2, the preceding vehicle identification apparatus 2000 includes an acquisition unit 2020, a reference point identification unit 2040, a relative position identification unit 2060, and a preceding vehicle identification unit 2080. The acquisition unit 2020 acquires the front information 50. The reference point identification unit 2040 identifies a reference point of the target vehicle 10 in captured image 30 using the front information 50. The relative position identification unit 2060 identifies a relative position (a combination of a relative distance and a relative direction) of each vehicle using the front information 50. The preceding vehicle identification unit 2080 identifies the preceding vehicle for the target vehicle 10 based on the relative position of each vehicle.

### Example of Hardware Configuration

Each functional component of the preceding vehicle identification apparatus 2000 may be implemented by hardware (for example, a hard-wired electronic circuit or the like) that implements each functional component, or may be implemented by a combination of hardware and software (for example, a combination of an electronic circuit and a program that controls the electronic circuit or the like). Hereinafter, a case where each functional component of the preceding vehicle identification apparatus 2000 is implemented by a combination of hardware and software will be further described.

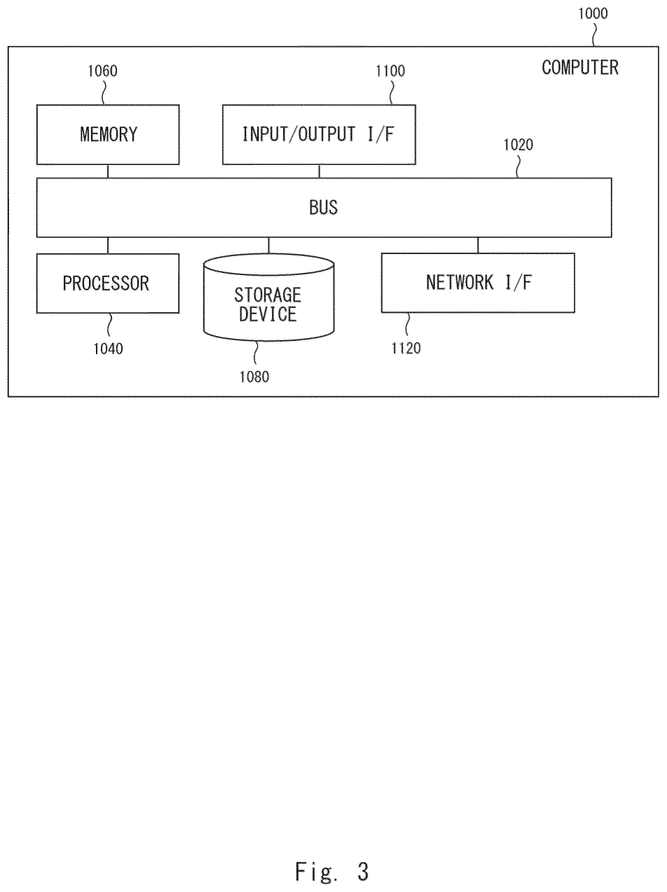

FIG. 3 is a block diagram illustrating a hardware configuration of a computer 1000 that implements the preceding vehicle identification apparatus 2000. The computer 1000 is any computer. For example, the computer 1000 is a stationary computer such as a personal computer (PC) or a server machine. In another example, the computer 1000 is a portable computer such as a smartphone or a tablet terminal. The computer 1000 may be provided inside the camera 20. The computer 1000 may be a dedicated computer designed for implementing the preceding vehicle identification apparatus 2000, or may be a general-purpose computer.

For example, by installing a predefined application in the computer 1000, each function of the preceding vehicle identification apparatus 2000 is implemented by the computer 1000. The above application includes a program for implementing each functional component of the preceding vehicle identification apparatus 2000.

The method of acquiring the program is any method. For example, the program can be acquired from a storage medium (Digital Versatile Disc (DVD), Universal Serial Bus (USB) memory, and the like) in which the program is stored. The program can also be acquired, for example, by downloading the program from a server apparatus that manages the storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, the method of connecting the processor 1040 and the like to each other is not limited to the bus connection.

The processor 1040 is various processors such as a central processing unit (CPU), a graphics processing unit (GPU), a digital signal processor (DSP), or a field-programmable gate array (FPGA). The memory 1060 is a main storage device achieved using a random access memory (RAM) or the like. The storage device 1080 is an auxiliary storage device achieved using a hard disk, a solid state drive (SSD), a memory card, a read only memory (ROM), or the like. The input/output interface 1100 is an interface connecting the computer 1000 with an input/output device. For example, an input apparatus such as a keyboard and an output apparatus such as a display apparatus are connected to the input/output interface 1100.

The network interface 1120 is an interface connecting the computer 1000 to a network. The network may be a local area network (LAN) or a wide area network (WAN).

The storage device 1080 stores a program that implements each functional component of the preceding vehicle identification apparatus 2000 (a program that implements the above-described application). The processor 1040 reads the program into the memory 1060 and executes the program to implement each functional component of the preceding vehicle identification apparatus 2000.

The preceding vehicle identification apparatus 2000 may be achieved by one computer 1000 or may be achieved by a plurality of computers 1000. In the latter case, the configurations of the computers 1000 do not need to be the same, and can be different from each other.

### Flow of Processing

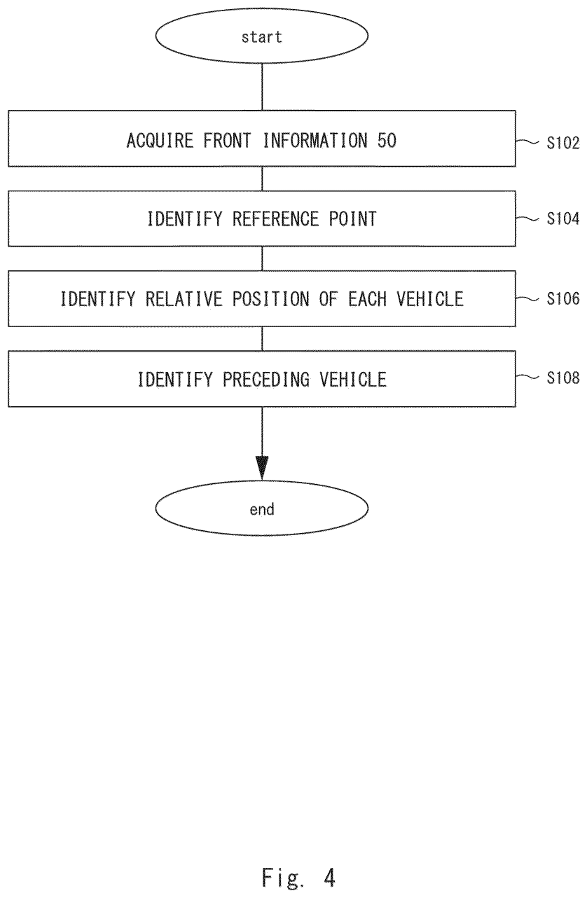

FIG. 4 is a flowchart illustrating a flow of processing executed by the preceding vehicle identification apparatus 2000. The acquisition unit 2020 acquires the front information 50 (S102). The reference point identification unit 2040 identifies a reference point using the front information 50 (S104). The relative position identification unit 2060 identifies the relative position of each vehicle using the front information 50 (S106). The preceding vehicle identification unit 2080 identifies the preceding vehicle for the target vehicle 10 based on the relative position of each vehicle (S108).

As described above, the image frame constituting an image frame sequence can be used as the captured image 30. In a case where the image frame is used as the captured image 30, for example, the preceding vehicle identification apparatus 2000 identifies the preceding vehicle for each image frame constituting the image frame sequence by acquiring the front information 50 generated for each image frame (captured image 30) constituting the image frame sequence.

The image frame sequence may include all the image frames generated by the camera 20, or may include part of the image frames generated by the camera 20. In the latter case, for example, the image frame is extracted at a ratio of one to a predefined number (for example, 1 in 30 frames) from the image frames generated by the camera 20, and an image frame sequence is constituted by the extracted image frames.

### Acquisition of Front Information 50: S102

The acquisition unit 2020 acquires the front information 50 (S102). The front information 50 is generated by the front information generation apparatus. The front information generation apparatus may be implemented separately from the preceding vehicle identification apparatus 2000, or may be implemented integrally with the preceding vehicle identification apparatus 2000. The latter means that the preceding vehicle identification apparatus 2000 also functions as a front information generation apparatus.

In a case where the preceding vehicle identification apparatus 2000 also functions as a front information generation apparatus, the acquisition unit 2020 acquires the front information 50 generated by the preceding vehicle identification apparatus 2000 itself. For example, the preceding vehicle identification apparatus 2000 is configured to generate the front information 50 and store the generated front information 50 in any storage unit (for example, the storage device 1080). The acquisition unit 2020 acquires the front information 50 from the storage unit.

It is assumed that the front information generation apparatus is achieved separately from the preceding vehicle identification apparatus 2000. In this case, the front information generation apparatus is configured to transmit the front information 50 to the preceding vehicle identification apparatus 2000, for example. In this case, the acquisition unit 2020 acquires the front information 50 by receiving the front information 50 transmitted from the front information generation apparatus. In addition, for example, the front information generation apparatus is configured to store the front information 50 in any storage unit. In this case, acquisition unit 2020 acquires the front information 50 by reading the front information 50 from the storage unit in which front information 50 is stored.

### Method of Generating Front Information 50

A method of generating the front information 50 will be described. As described above, the front information 50 indicates the road information 60 and the vehicle information 70.

For example, the front information generation apparatus performs segmentation processing such as a panoramic segmentation on the captured image 30 to divide the captured image 30 into image regions representing each of a plurality of objects. The front information generation apparatus extracts a road region from the image region obtained by the division, and generates road information 60.

For example, the front information generation apparatus identifies a circumscribed rectangle of the road region, and generates road information 60 indicating the position and the dimension of the circumscribed rectangle. The position of the circumscribed rectangle is represented by, for example, coordinates of a specific position (upper left end or center) of the circumscribed rectangle. The dimension of the circumscribed rectangle is represented by, for example, a combination of the width and the height of the circumscribed rectangle.

Not only an image region representing a road in the traveling direction of the target vehicle 10 but also an image region representing a road in a direction (for example, in a direction opposite to the traveling direction) different from the traveling direction of the target vehicle 10 can be detected from the captured image 30. That is, a plurality of road regions can be detected from the captured image 30.

When a plurality of road regions is detected from the captured image 30, the front information generation apparatus identifies a road region (that is, a road region representing a road in the traveling direction of the target vehicle 10) including the target lane from the plurality of road regions obtained from the captured image 30 to generate the road information 60 for the identified road region. Hereinafter, the road region including the target lane is referred to as a target road region.

For example, the front information generation apparatus identifies a road region having the largest size among a plurality of road regions obtained from the captured image 30 as a target road region. In addition, for example, the front information generation apparatus calculates center coordinates of the captured image 30 in the horizontal direction, and identifies a road region including the center coordinates in the horizontal direction as a target road region. When the upper left end of the captured image 30 is the origin and the width of the captured image 30 is W, the center coordinate of the captured image 30 in the horizontal direction is x=W/2.

Further, the front information generation apparatus generates the vehicle information 70 for a vehicle region that is an image region representing a vehicle among a plurality of image regions obtained by segmentation. For example, the front information generation apparatus identifies a circumscribed rectangle of the vehicle region and generates the vehicle information 70 indicating a position of the circumscribed rectangle. The vehicle information 70 includes information about each of one or more vehicles detected from captured image 30. In addition to the position of the circumscribed rectangle, the vehicle information 70 may further indicate the dimension of the circumscribed rectangle.

A method of detecting a road region or a vehicle region from the captured image 30 is not limited to a method using segmentation. For example, a road region may be detected from the captured image 30 using any machine learning model (such as a neural network) that is pre-trained to detect the road region from the image. Similarly, the vehicle region may be detected from the captured image 30 using any machine learning model (such as a neural network) that is pre-trained to detect the vehicle region from the image.

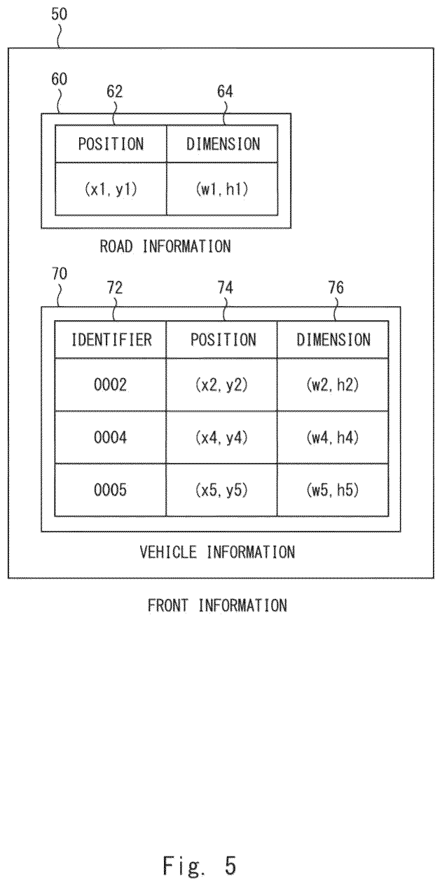

FIG. 5 is a diagram illustrating a configuration of the front information 50. In FIG. 5, front information 50 indicates the road information 60 and the vehicle information 70. The road information 60 indicates a position 62 and a dimension 64. The position 62 represents the position of the circumscribed rectangle of the target road region. The dimension 64 indicates the width the and height of the circumscribed rectangle of the target road region.

The vehicle information 70 indicates an identifier 72, a position 74, and a dimension 76 for each vehicle. The identifier 72 is an identifier uniquely allocated to each vehicle detected from captured image 30 by the front information generation apparatus. The position 74 represents the position of the circumscribed rectangle of the vehicle. The dimension 76 represents the width the and height of the circumscribed rectangle of the vehicle.

In a case where each image frame constituting the image frame sequence is treated as the captured image 30, it is preferable that the same identifiers are allocated to the same vehicles detected from the plurality of captured images 30. The processing of allocating the same identifiers to the same objects detected from the plurality of different images can be implemented by, for example, identification processing using tracking or the like.

### Acquisition of Captured Image 30

In a case where the preceding vehicle identification apparatus 2000 also functions as a front information generation apparatus, the acquisition unit 2020 acquires the captured image 30. There are various methods of acquiring the image generated by the camera. For example, the camera 20 is configured to transmit the captured image 30 to the preceding vehicle identification apparatus 2000. In this case, the acquisition unit 2020 acquires the captured image 30 by receiving the captured image 30 transmitted by the camera 20. In addition, for example, the camera 20 is configured to store the captured image 30 in any storage unit. The storage unit may be provided inside the camera 20 or may be provided outside the camera 20. The acquisition unit 2020 acquires the captured image 30 from the storage unit, for example, by accessing the storage unit.

The acquisition unit 2020 may acquire the captured image 30 by acquiring an image frame sequence and extracting one or more captured images 30 from the acquired image frame sequence. As a method of acquiring the image frame sequence, a method similar to the method of acquiring the captured image 30 described above can be used.

### Identification of Reference Point: S104

The reference point identification unit 2040 identifies a reference point of the target vehicle 10 in captured image 30 using front information 50 (S104). The reference point is identified as follows, for example, based on the road information 60.

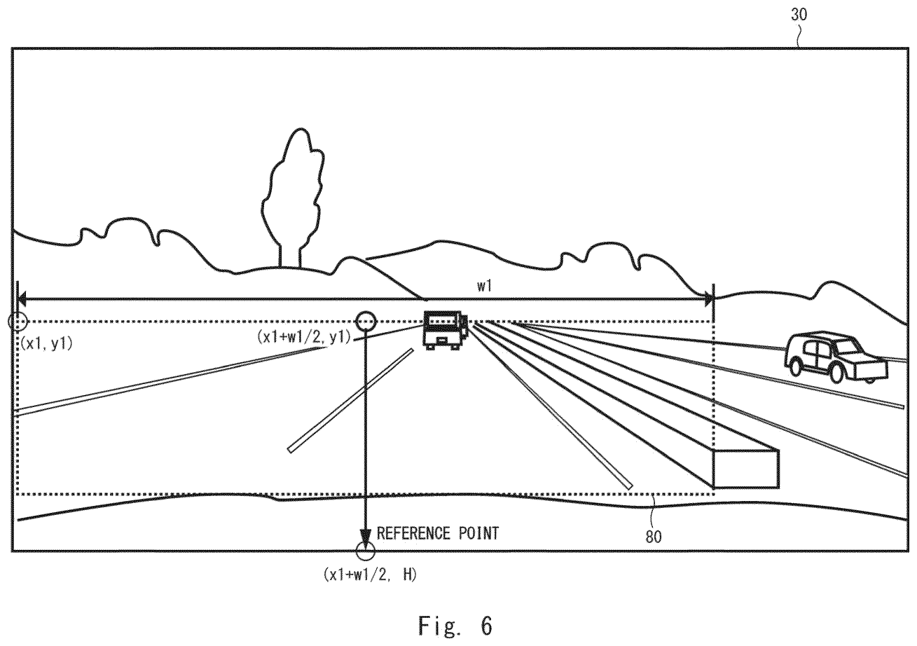

FIG. 6 is a diagram illustrating reference points. In FIG. 6, an upper left end of the captured image 30 is an origin (0, 0). The width the and height of the entire captured image 30 are W and H, respectively.

First, the reference point identification unit 2040 identifies the center coordinates (hereinafter, horizontal center coordinate) of a circumscribed rectangle 80 of the target road region in the horizontal direction using the road information 60. The horizontal direction can also be expressed as the x direction.

For example, it is assumed that the road information 60 indicates the position (x, y)=(x1, y1) of the upper left end of the circumscribed rectangle 80 and the dimension (w, h)=(w1, h1) of the circumscribed rectangle 80. w represents a width, and h represents a height. In this case, the reference point identification unit 2040 calculates the horizontal center coordinate (x=x1+w/2) by adding w/2, which is half the width w of the circumscribed rectangle 80, to x1, which is the x coordinate of the upper left end of the circumscribed rectangle 80. The horizontal center coordinates may be directly indicated by the road information 60 as a value representing the position of the circumscribed rectangle 80.

Next, the reference point identification unit 2040 identifies a point at which the coordinate in the horizontal direction matches the horizontal center coordinate on the bottom side of the captured image 30 as a reference point 100. That is, the reference point 100 is (x1+w/2, H).

The reference point identification unit 2040 may calculate the reference point 100 by further considering the size of the width of the circumscribed rectangle 80, which is the circumscribed rectangle of the target road region, with respect to the width of the entire captured image 30. For example, the reference point identification unit 2040 calculates the width of a range (hereinafter, an empty range) obtained by excluding the range of the circumscribed rectangle 80 in the horizontal direction from the range of the entire captured image 30 in the horizontal direction. Since the width of the entire captured image 30 is W and the width of the circumscribed rectangle 80 is w1, the width of the empty range is W−w1. The reference point identification unit 2040 calculates the x coordinate of the reference point 100 based on the width W−w1 of the empty range and x1+w/2 which is the horizontal center coordinate.

For example, the reference point identification unit 2040 calculates the x coordinate of the reference point 100 as follows. First, the reference point identification unit 2040 determines whether the width W−w1 of the empty range is larger than 1/n times the width W of the entire captured image 30. That is, the reference point identification unit 2040 determines whether W−w1>W/n is satisfied. n is a predefined positive integer.

In a case where W−w1>W/n, the reference point identification unit 2040 moves the x coordinate of the reference point in the horizontal direction from x1+w/2 by (W−w1)/2. On the other hand, in a case where W−w1>W/n is not satisfied, the reference point identification unit 2040 moves the x coordinate of the reference point in the horizontal direction from x1+w/2 by W−w1.

The x coordinate of the reference point is moved in such a way as to approach the empty range. That is, when the empty range is located left of the road (that is, a case where the circumscribed rectangle 80 is located on the right side of the captured image 30.), the x coordinate of the reference point is moved from x1+w/2 to the left. On the other hand, when the empty range is located right of the road (that is, a case where the circumscribed rectangle 80 is located on the left side of the captured image 30), the x coordinate of the reference point is moved rightward from x1+w/2.

### Identification of Relative Position: S106

The relative position identification unit 2060 identifies the relative position of each vehicle using the front information 50 (S106). As described above, the relative position is a combination of a relative distance and a relative direction.

The relative position identification unit 2060 calculates the relative distance to the reference point for each vehicle of which vehicle information 70 is indicated in front information 50. Specifically, the relative position identification unit 2060 calculates the distance between the position 74 of the vehicle and the reference point 100 as the relative distance for each vehicle.

The relative position identification unit 2060 calculates a straight line connecting the position 74 of the vehicle and the reference point 100 for each vehicle whose vehicle information 70 is indicated in the front information 50, and identifies the relative direction of the vehicle based on the straight line. For example, the relative direction is represented by an inclination (a in y=ax+b) of a straight line connecting the position 74 and the reference point 100. In addition, for example, the relative direction is represented by an angle formed by a straight line connecting the position 74 and the reference point 100 and a straight line representing a reference direction. As the straight line representing the reference direction, any straight line passing through the reference point can be used. An example of the straight line passing through the reference point is a straight line passing through the reference point and parallel to the height direction of the captured image 30.

### Identification of Preceding Vehicle: S114

The preceding vehicle identification unit 2080 identifies a preceding vehicle from among vehicles whose vehicle information 70 is indicated in the front information 50 (S114). First, the preceding vehicle identification unit 2080 identifies a vehicle traveling in the target lane based on the relative direction identified for each vehicle. The preceding vehicle identification unit 2080 identifies a vehicle having the smallest relative distance among the vehicles traveling on the target lane as a preceding vehicle.

Whether the vehicle is traveling in the target lane can be determined using, for example, a numerical range of a predefined relative direction. That is, the numerical range of the relative direction that can be taken by the vehicle traveling on the target lane is determined in advance. For each vehicle, the preceding vehicle identification unit 2080 determines whether the relative direction of the vehicle is included in this predefined numerical range. When the relative direction of the vehicle is included in the predefined numerical range, the preceding vehicle identification unit 2080 determines that the vehicle is traveling on the target lane. On the other hand, when the relative direction of the vehicle is not included in the predefined numerical range, the preceding vehicle identification unit 2080 determines that the vehicle is not traveling on the target lane.

### Output of Processing Result

The preceding vehicle identification apparatus 2000 outputs information indicating a processing result (hereinafter, result information). The result information is information that can identify the preceding vehicle. For example, the result information indicates the identifier 72 of the preceding vehicle. In addition, for example, the result information may indicate the position 74 of the preceding vehicle.

When the preceding vehicle identification apparatus 2000 identifies the preceding vehicle for each of the plurality of pieces of the front information 50, the result information further indicates an identifier of the front information 50. As the identifier of the front information 50, for example, the identifier of the captured image 30 used to generate the front information 50 is used. The identifier of the captured image 30 is, for example, a file name of the captured image 30, a frame number of the captured image 30 in an image frame sequence, or the like.

### Second Example Embodiment

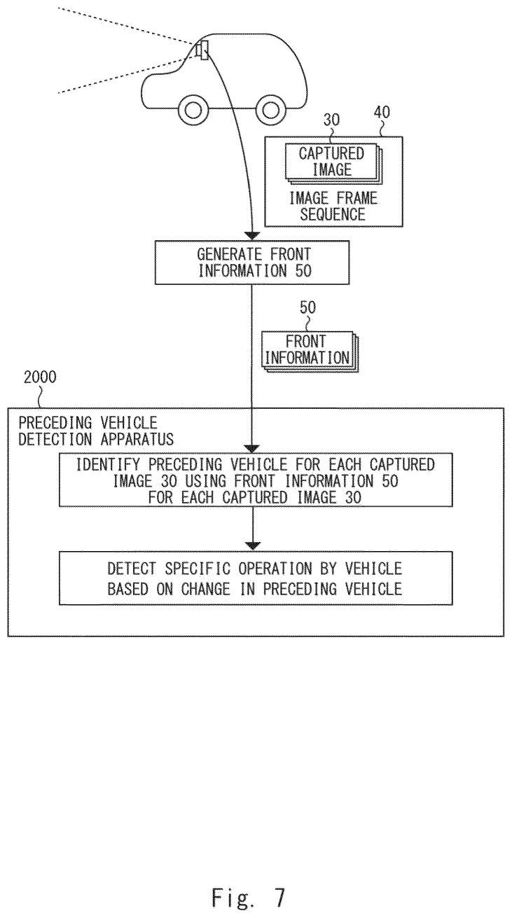

FIG. 7 is a second diagram illustrating an outline of the operation of the preceding vehicle identification apparatus 2000. FIG. 7 is a diagram for facilitating understanding of the outline of the preceding vehicle identification apparatus 2000, and the operation of the preceding vehicle identification apparatus 2000 is not limited to that illustrated in FIG. 1.

The preceding vehicle identification apparatus 2000 of the second example embodiment acquires the front information 50 for each of the plurality of captured images 30 constituting an image frame sequence 40, thereby detecting the preceding vehicle for each of the captured images 30. The preceding vehicle identification apparatus 2000 of the second example embodiment detects a predefined operation by a vehicle other than the target vehicle 10 based on the detected change in the preceding vehicle. For example, the predefined operation is a cut-in or a cut-out.

The cut-in is an operation of “changing from a state of not being a preceding vehicle to a state of being a preceding vehicle by changing a lane from a lane other than the target lane to the target lane”. The cutout is an operation of “changing from a state of being a preceding vehicle to a state of not being a preceding vehicle by changing a lane from a target lane to a lane other than the target lane”.

### Example of Operation and Effect

According to the preceding vehicle identification apparatus 2000 of the present example embodiment, the preceding vehicle for the target vehicle 10 is identified from each image frame constituting the image frame sequence 40. Based on the change in the preceding vehicle, it is detected that a specific operation (cut-in, cut-out, or the like) is performed by a vehicle other than the target vehicle 10. Therefore, according to the preceding vehicle identification apparatus 2000, it is possible to easily and automatically detect, from the image frame sequence 40, that a specific operation was performed by a vehicle other than the target vehicle 10.

Detection of a specific operation such as cut-in or cut-out is useful for analysis of a situation of a traffic accident when the accident occurs, for example. An operation such as cut-in or cut-out may cause a traffic accident. Therefore, by analyzing the image frame sequence 40 and detecting a specific operation such as cut-in or cut-out, it is possible to easily collect information about an operation that may cause a traffic accident.

It is also conceivable to use a portion (hereinafter, the partial frame sequence) representing a specific operation such as cut-in or cut-out in the image frame sequence 40 for training of the machine learning model. A large amount of training data is required for training the machine learning model. However, obtaining a large amount of training data is labor intensive.

For example, it is assumed that a partial frame sequence representing a cut-in or a cutout is required to be manually extracted from the image frame sequence 40. In this case, the operator is required to reproduce the image frame sequence 40 using moving image editing software or the like to detect an operation such as cut-in or cut-out. Such work requires time and labor.

In this regard, using the preceding vehicle identification apparatus 2000, it is possible to easily identify a cut-in or a cut-out portion. Therefore, according to the preceding vehicle identification apparatus 2000, it is easy to generate training data used for training of a machine learning model.

Hereinafter, the preceding vehicle identification apparatus 2000 of the present example embodiment will be described in more detail.

### Example of Functional Configuration

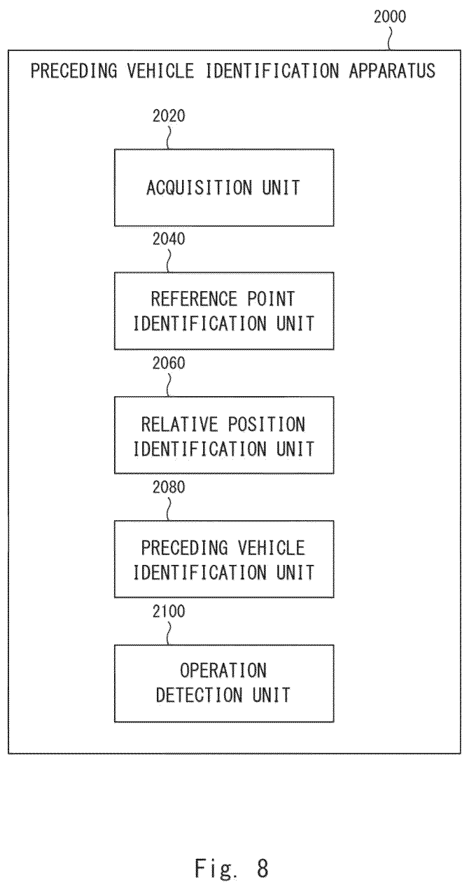

FIG. 8 is a second block diagram illustrating a functional configuration of the preceding vehicle identification apparatus 2000. In the example of FIG. 2, the preceding vehicle identification apparatus 2000 includes an acquisition unit 2020, a reference point identification unit 2040, a relative position identification unit 2060, a preceding vehicle identification unit 2080, and an operation detection unit 2100. The operation detection unit 2100 detects a specific operation of a vehicle other than the target vehicle 10 based on a change in the preceding vehicle.

### Example of Hardware Configuration

The hardware configuration of the preceding vehicle identification apparatus 2000 of the second example embodiment can be represented in FIG. 3 as in the hardware configuration of the preceding vehicle identification apparatus 2000 of the first example embodiment. However, the storage device 1080 of the second example embodiment stores a program for implementing the functional configuration of the preceding vehicle identification apparatus 2000 of the second example embodiment.

### Flow of Processing

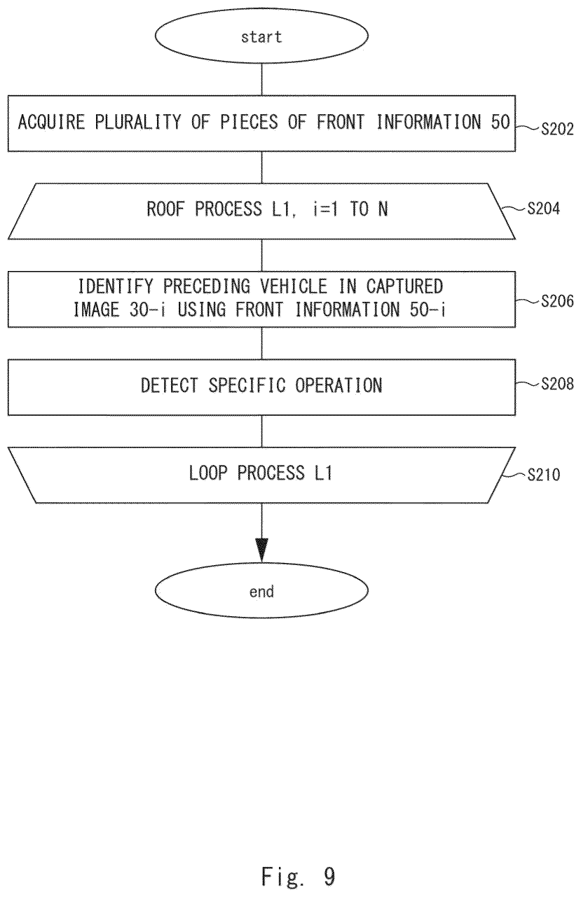

FIG. 9 is a second flowchart illustrating a flow of processing executed by the preceding vehicle identification apparatus 2000. The acquisition unit 2020 acquires the front information 50 for each captured image 30 constituting the image frame sequence 40 (S202). Hereinafter, the i-th captured image 30 in the image frame sequence 40 is denoted as a captured image 30-i. The front information 50 generated for the captured image 30-i is denoted as front information 50-i.

S204 to S210 constitute a loop process L1 performed for each front information 50-i. The initial value of i is 1. Also, the value of i is incremented by one at the end of each iteration. Furthermore, the total number of captured images 30 constituting the image frame sequence 40 is represented as N (N is an integer of 2 or more).

In S204, the preceding vehicle identification apparatus 2000 determines whether i is N or less. In a case where i is larger than N, the execution of the loop process L1 is terminated. On the other hand, in a case where i is equal to or less than N, S206 is executed.

In S206, the preceding vehicle identification apparatus 2000 identifies the preceding vehicle in the captured image 30-i using the front information 50-i. The process executed in S206 corresponds to a series of processes (S104 to S108) performed by the preceding vehicle identification apparatus 2000 of the first example embodiment using the front information 50.

The operation detection unit 2100 detects the specific operation based on the result of identifying the preceding vehicle in S206 (S208). For example, in a case where cut-in and cut-out are handled as the specific operation, the operation detection unit 2100 attempts to detect cut-in and cut-out in S208. The plurality of specific operations may be detected in order or in parallel.

Step S210 is a termination of the loop process L1. Therefore, after the value of i is incremented by one, the next iteration of the loop process L1 is executed.

### Acquisition of Front Information 50: S202

The acquisition unit 2020 acquires the front information 50 generated for each captured image 30 constituting the image frame sequence 40. The method of acquiring the front information 50 for one captured image 30 is as described in the first example embodiment.

The acquisition unit 2020 may acquire all the front information 50 obtained from the image frame sequence 40 at a time, or may acquire the front information 50 a plurality of times. In the latter case, for example, the front information generation apparatus is configured to generate the front information 50 for the generated captured image 30 each time the captured image 30 is generated by the camera 20. In other words, the front information generation apparatus is configured to generate the front information 50 from the captured image 30 in real time. The acquisition unit 2020 acquires the front information 50 every time new front information 50 is generated.

### Detection of Specific Operation: S208

The operation detection unit 2100 detects the specific operation based on the result of the determination of the preceding vehicle (S208). As described above, the specific operation is, for example, cut-in or cut-out. Hereinafter, a method of detecting cut-in and cut-out will be described.

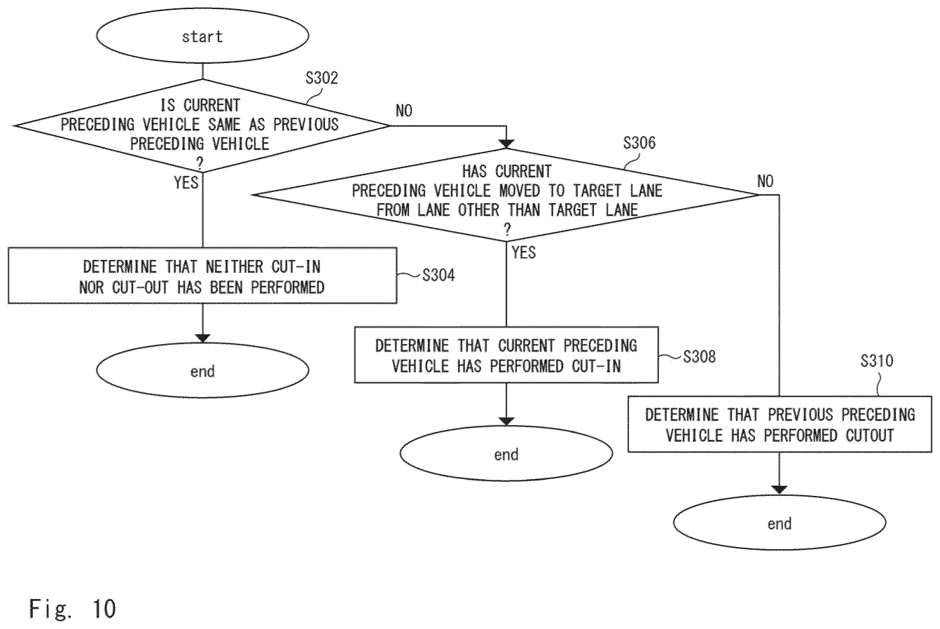

FIG. 10 is a flowchart illustrating a flow of processing of detecting cut-in and cut-out. The operation detection unit 2100 determines whether the current preceding vehicle is the same as the previous preceding vehicle (S302). The current preceding vehicle is a preceding vehicle for the captured image 30-i, and the previous preceding vehicle is a preceding vehicle for the captured image 30-(i−1).

When the current preceding vehicle is the same as the previous preceding vehicle (S302: YES), the operation detection unit 2100 determines that neither the cut-in nor the cut-out has been performed (S304). On the other hand, when the current preceding vehicle is different from the previous preceding vehicle (S302: NO), the operation detection unit 2100 determines whether the current preceding vehicle has moved to the target lane from a lane other than the target lane (S306). When the current preceding vehicle has moved from a lane other than the target lane to the target lane (S306: YES), the operation detection unit 2100 determines that the cut-in has been performed by the current preceding vehicle (S308). On the other hand, when the current preceding vehicle has not moved from a lane other than the target lane to the target lane (S306: NO), the operation detection unit 2100 determines that the cutout has been performed by the previous preceding vehicle (S310).

The movement of the lane by the vehicle can be identified based on the history of the relative direction of the vehicle. For example, it is assumed that a straight line passing through the reference point and parallel to the vertical direction of the captured image 30 is treated as a reference line representing the reference direction. In a case where the relative direction of a certain vehicle changes in such a way as to approach the reference direction, and as a result, the relative direction of the vehicle is included in a predefined range indicating that the vehicle is traveling in the target lane, the operation detection unit 2100 determines that the vehicle has moved from a lane other than the target lane to the target lane. On the other hand, in a case where the relative direction of a certain vehicle changing in such a way as to be away from the reference direction and as a result, the relative direction of the vehicle is not included in the predefined range indicating that the vehicle is traveling in the target lane, the operation detection unit 2100 determines that the vehicle has moved from the target lane to a lane other than the target lane.

In the flowchart of FIG. 10, detection of cut-in is performed before detection of cutout. However, the detection of the cutout may be performed before the detection of the cut-in. A series of processes for detecting cut-in and a series of processes for detecting cutout may be performed independently of each other.

It is also conceivable that the target vehicle 10 itself performs a lane change. Therefore, when it is determined that the current preceding vehicle is different from the previous preceding vehicle (S302: NO), the operation detection unit 2100 may determine whether the target vehicle 10 has made a lane change. When it is determined that the target vehicle 10 has made a lane change, the operation detection unit 2100 determines that neither cut-in nor cut-out has been performed (S304). On the other hand, when it is determined that the target vehicle 10 has not made a lane change, the operation detection unit 2100 executes S306.

### Other Specific Operations

The specific operation is not limited to the cut-in and the cut-out. The other specific operation is, for example, an operation of “the preceding vehicle becomes a distant vehicle”. The distant vehicle is a vehicle that “is traveling in the target lane and is a vehicle closest to the target vehicle 10 but is traveling at a position far away from the target vehicle 10”. In a case where the vehicle is traveling in the target lane and is closest to the target vehicle 10, but is traveling at a position far away from the target vehicle 10, the probability of affecting the traveling of the target vehicle 10 is low. Therefore, for example, the preceding vehicle identification apparatus 2000 treats such a vehicle as a distant vehicle and distinguishes it from the preceding vehicle.

For example, in a case where the current preceding vehicle and the previous preceding vehicle are the same (S302: YES), the operation detection unit 2100 determines whether the relative distance of the current preceding vehicle is equal to or more than the threshold value. When the relative distance of the current preceding vehicle is equal to or more than the threshold value, the operation detection unit 2100 determines that the operation of “becoming a distant vehicle” has been performed. The vehicle that has performed the operation of becoming a preceding vehicle is both the previous preceding vehicle and the current preceding vehicle.

### Output of Result Information

The preceding vehicle identification apparatus 2000 outputs result information. For example, the result information indicates information about each of one or more specific operations detected from the image frame sequence 40. The information about the specific operation indicates, for example, a type of the detected specific operation, an identifier of a vehicle that has performed the specific operation, and a time point at which the specific operation has been performed. The time point at which the specific operation is performed is represented, for example, at the time point at which the captured image 30 in which the specific operation is detected is generated.

The result information may indicate a period during which the specific operation is performed instead of the time point when the specific operation is performed or in addition to the time point when the specific operation is performed. The period during which the specific operation is performed is set as, for example, a period from a predefined time before to a predefined time after the time point at which the specific operation is performed.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example to illustrate one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for describing illustrative example embodiments are not necessarily mandatory, and some features or steps may be omitted. The order of the steps described in any of the figures may be changed as appropriate.

Some or all of the above-described example embodiments may be described as the following Supplementary Notes, but are not limited to the following Supplementary Notes.

Some or all of the above-described example embodiments may be described as the following Supplementary Notes, but are not limited to the following Supplementary Notes.

### Supplementary Note 1

A preceding vehicle identification apparatus including
an acquisition means for acquiring front information including information about a region of a road included in a captured image obtained by capturing an image of a scene in front of a target vehicle and information about one or more vehicles on the road,
a reference point identification means for identifying a reference point of the target vehicle in the captured image using the front information,
a relative position identification means for identifying a relative distance and a relative direction with respect to the reference point for each vehicle indicated in the front information, and
a preceding vehicle identification means for identifying a preceding vehicle for the target vehicle based on the relative distance and the relative direction identified for the each vehicle,
wherein the preceding vehicle is a vehicle closest to the target vehicle among vehicles traveling on a lane same as a lane of the target vehicle.

### Supplementary Note 2

The preceding vehicle identification apparatus according to Supplementary Note 1, wherein
the front information indicates a width and a position of an image region representing a road in front of the target vehicle, and
the reference point identification means identifies a position of the reference point in a horizontal direction based on the width and the position of an image region representing the road in front of the target vehicle.

### Supplementary Note 3

The preceding vehicle identification apparatus according to Supplementary Note 1 or 2, wherein the relative position identification means identifies an inclination of a straight line passing through a position of the vehicle and the reference point as a relative direction of the vehicle.

### Supplementary Note 4

The preceding vehicle identification apparatus according to Supplementary Note 1 or 2, wherein the preceding vehicle identification means identifies a vehicle the relative direction of which is included in a predefined range as a vehicle traveling on a lane same as a lane of the target vehicle.

### Supplementary Note 5

The preceding vehicle identification apparatus according to Supplementary Note 1 or 2, wherein
the acquisition means acquires the front information related to each of the plurality of captured images generated by repeatedly capturing an image of a scene in front of the target vehicle, and
the preceding vehicle identification means identifies the preceding vehicle for each of the plurality of pieces of front information, and
includes an operation detection means for detecting a predefined operation by the vehicle based on a change in the identified preceding vehicle.

### Supplementary Note 6

The preceding vehicle identification apparatus according to Supplementary Note 5, wherein the operation detection means detects, as the predefined operation, an operation of becoming the preceding vehicle by moving from a lane on which the target vehicle is not traveling to a lane on which the target vehicle is traveling, or an operation of becoming not the preceding vehicle by moving from a lane on which the target vehicle is traveling to a lane on which the target vehicle is not traveling.

### Supplementary Note 7

The preceding vehicle identification apparatus according to Supplementary Note 6, wherein the operation detection means detects, based on a change in a relative direction of the vehicle, that the vehicle has moved from a lane on which the target vehicle is not traveling to a lane on which the target vehicle is traveling, or that the vehicle has moved from a lane on which the target vehicle is traveling to a lane on which the target vehicle is not traveling.

### Supplementary Note 8

A preceding vehicle identification method including
an acquisition step of acquiring front information including information about a region of a road included in a captured image obtained by capturing an image of a scene in front of a target vehicle and information about one or more vehicles on the road,
a reference point identification step of identifying a reference point of the target vehicle in the captured image using the front information,
a relative position identification step of identifying a relative distance and a relative direction with respect to the reference point for each vehicle indicated in the front information, and
a preceding vehicle identification step of identifying a preceding vehicle for the target vehicle based on the relative distance and the relative direction identified for the each vehicle,
wherein the preceding vehicle is a vehicle closest to the target vehicle among vehicles traveling on a lane same as a lane of the target vehicle.

### Supplementary Note 9

The preceding vehicle identification method according to Supplementary Note 8, wherein
the front information indicates a width and a position of an image region representing a road in front of the target vehicle, and
the reference point identification step includes identifying a position of the reference point in a horizontal direction based on the width and the position of an image region representing the road in front of the target vehicle.

### Supplementary Note 10

A program for causing a computer to execute
an acquisition step of acquiring front information including information about a region of a road included in a captured image obtained by capturing an image of a scene in front of a target vehicle and information about one or more vehicles on the road,
a reference point identification step of identifying a reference point of the target vehicle in the captured image using the front information,
a relative position identification step of identifying a relative distance and a relative direction with respect to the reference point for each vehicle indicated in the front information, and
a preceding vehicle identification step of identifying a preceding vehicle for the target vehicle based on the relative distance and the relative direction identified for the each vehicle,
wherein the preceding vehicle is a vehicle closest to the target vehicle among vehicles traveling on a lane same as a lane of the target vehicle.

Some or all of the elements (for example, configurations and functions) described in supplementary notes 3 to 7 dependent on supplementary note 1 can also depend on supplementary note 8 (method) in the same dependency relationship as supplementary notes 3 to 7. Some or all of the elements (for example, configurations and functions) described in supplementary notes 2 to 7 dependent on supplementary note 1 can also depend on supplementary note 10 (program) in the same dependency relationship as supplementary notes 2 to 7.

1. A preceding vehicle identification apparatus comprising:
at least one memory that is configured to store instructions; and
at least one processor that is configured to execute the instructions to:
acquiring front information including information about a region of a road included in a captured image obtained by capturing an image of a scene in front of a target vehicle and information about one or more vehicles on the road;
identifying a reference point of the target vehicle in the captured image using the front information;
identifying a relative distance and a relative direction with respect to the reference point for each vehicle indicated in the front information; and
identifying a preceding vehicle for the target vehicle based on the relative distance and the relative direction identified for the each vehicle,
wherein the preceding vehicle is a vehicle closest to the target vehicle among vehicles traveling on a lane same as a lane of the target vehicle.

2. The preceding vehicle identification apparatus according to claim 1,
wherein the front information indicates a width and a position of an image region representing a road in front of the target vehicle, and
wherein the identification of the reference point includes identifying a position of the reference point in a horizontal direction based on the width and the position of an image region representing the road in front of the target vehicle.

3. The preceding vehicle identification apparatus according to claim 1, wherein the identification of the relative direction includes identifying an inclination of a straight line passing through a position of the vehicle and the reference point as a relative direction of the vehicle.

4. The preceding vehicle identification apparatus according to claim 1, wherein the identification of the preceding vehicle includes identifying a vehicle the relative direction of which is included in a predefined range as a vehicle traveling on a lane same as a lane of the target vehicle.

5. The preceding vehicle identification apparatus according to claim 1,
wherein the acquisition of the front information includes acquiring the front information related to each of the plurality of captured images generated by repeatedly capturing an image of a scene in front of the target vehicle,
wherein the identification of the preceding vehicle includes identifying the preceding vehicle for each of the plurality of pieces of front information, and
wherein the at least one processor is further configured to detect a predefined operation by the vehicle based on a change in the identified preceding vehicle.

6. The preceding vehicle identification apparatus according to claim 5, wherein the detection of the predefined operation includes detecting, as the predefined operation, an operation of becoming the preceding vehicle by moving from a lane on which the target vehicle is not traveling to a lane on which the target vehicle is traveling, or an operation of becoming not the preceding vehicle by moving from a lane on which the target vehicle is traveling to a lane on which the target vehicle is not traveling.

7. The preceding vehicle identification apparatus according to claim 6, wherein the detection of the predefined operation includes detecting, based on a change in a relative direction of the vehicle, that the vehicle has moved from a lane on which the target vehicle is not traveling to a lane on which the target vehicle is traveling, or that the vehicle has moved from a lane on which the target vehicle is traveling to a lane on which the target vehicle is not traveling.

8. A preceding vehicle identification method performed by one or more computers, comprising:
acquiring front information including information about a region of a road included in a captured image obtained by capturing an image of a scene in front of a target vehicle and information about one or more vehicles on the road;
identifying a reference point of the target vehicle in the captured image using the front information;
identifying a relative distance and a relative direction with respect to the reference point for each vehicle indicated in the front information; and
identifying a preceding vehicle for the target vehicle based on the relative distance and the relative direction identified for the each vehicle,
wherein the preceding vehicle is a vehicle closest to the target vehicle among vehicles traveling on a lane same as a lane of the target vehicle.

9. The preceding vehicle identification method according to claim 8,
wherein the front information indicates a width and a position of an image region representing a road in front of the target vehicle, and
wherein the identification of the reference point includes identifying a position of the reference point in a horizontal direction based on the width and the position of an image region representing the road in front of the target vehicle.

10. The preceding vehicle identification method according to claim 8, wherein the identification of the relative direction includes identifying an inclination of a straight line passing through a position of the vehicle and the reference point as a relative direction of the vehicle.

11. The preceding vehicle identification method according to claim 8, wherein the identification of the preceding vehicle includes identifying a vehicle the relative direction of which is included in a predefined range as a vehicle traveling on a lane same as a lane of the target vehicle.

12. The preceding vehicle identification method according to claim 8,
wherein the acquisition of the front information includes acquiring the front information related to each of the plurality of captured images generated by repeatedly capturing an image of a scene in front of the target vehicle,
wherein the identification of the preceding vehicle includes identifying the preceding vehicle for each of the plurality of pieces of front information, and
wherein the preceding vehicle identification method further comprises detecting a predefined operation by the vehicle based on a change in the identified preceding vehicle.

13. The preceding vehicle identification method according to claim 12, wherein the detection of the predefined operation includes detecting, as the predefined operation, an operation of becoming the preceding vehicle by moving from a lane on which the target vehicle is not traveling to a lane on which the target vehicle is traveling, or an operation of becoming not the preceding vehicle by moving from a lane on which the target vehicle is traveling to a lane on which the target vehicle is not traveling.

14. The preceding vehicle identification method according to claim 13, wherein the detection of the predefined operation includes detecting, based on a change in a relative direction of the vehicle, that the vehicle has moved from a lane on which the target vehicle is not traveling to a lane on which the target vehicle is traveling, or that the vehicle has moved from a lane on which the target vehicle is traveling to a lane on which the target vehicle is not traveling.

15. A non-transitory computer-readable medium storing a program that causes one or more computers to execute:
acquiring front information including information about a region of a road included in a captured image obtained by capturing an image of a scene in front of a target vehicle and information about one or more vehicles on the road;
identifying a reference point of the target vehicle in the captured image using the front information;
identifying a relative distance and a relative direction with respect to the reference point for each vehicle indicated in the front information; and
identifying a preceding vehicle for the target vehicle based on the relative distance and the relative direction identified for the each vehicle,
wherein the preceding vehicle is a vehicle closest to the target vehicle among vehicles traveling on a lane same as a lane of the target vehicle.

16. The medium according to claim 15,
wherein the front information indicates a width and a position of an image region representing a road in front of the target vehicle, and
wherein the identification of the reference point includes identifying a position of the reference point in a horizontal direction based on the width and the position of an image region representing the road in front of the target vehicle.

17. The medium according to claim 15, wherein the identification of the relative direction includes identifying an inclination of a straight line passing through a position of the vehicle and the reference point as a relative direction of the vehicle.

18. The medium according to claim 15, wherein the identification of the preceding vehicle includes identifying a vehicle the relative direction of which is included in a predefined range as a vehicle traveling on a lane same as a lane of the target vehicle.

19. The medium according to claim 15,
wherein the acquisition of the front information includes acquiring the front information related to each of the plurality of captured images generated by repeatedly capturing an image of a scene in front of the target vehicle,
wherein the identification of the preceding vehicle includes identifying the preceding vehicle for each of the plurality of pieces of front information, and
wherein the program causes the one or more computers to further execute detecting a predefined operation by the vehicle based on a change in the identified preceding vehicle.

20. The medium according to claim 19, wherein the detection of the predefined operation includes detecting, as the predefined operation, an operation of becoming the preceding vehicle by moving from a lane on which the target vehicle is not traveling to a lane on which the target vehicle is traveling, or an operation of becoming not the preceding vehicle by moving from a lane on which the target vehicle is traveling to a lane on which the target vehicle is not traveling.
